(19) United States
(12) Patent Application Publication
(10) Pub. No.: US 2018/0293887 A1
(43) Pub. Date: Oct. 11, 2018

(54) System and method for visualization of traffic patterns

(71) Applicant: Gregory Brodski, Warwick, MA (US)

(72) Inventors: Gregory Brodski, Warwick, MA (US); Andrey Berkovsky, Saint-Petersburg (RU); Mikhail Bakhtin, Saint-Petersburg (RU); Arthur Stepanyan, Albany, CA (US)

(21) Appl. No.: 15/479,334

(22) Filed: Apr. 5, 2017

(51) Int. Cl. G08G 1/0967

(52) U.S. Cl. CPC G08G 1/0967

(57) ABSTRACT

An integrated system and method for visualization of traffic patterns, applicable to one or more road or road network, which obtains information on each segment of road network, organizes the segments into road sections, and defines traffic flow speed, traffic flow volume, maximal capacity and speed limit for each segment for each period of time. Based on the accumulated values, the system builds the road network map, assigning to each section a color in accordance with the speed-related parameter and a width in accordance with flow volume related parameter. The system may provide different traffic flow volume and traffic speed related parameters according to the user request, which ensures situation awareness and situation understanding at a glance.

### BACKGROUND OF THE INVENTION

This invention relates to a method and system for visualization of traffic patterns using GPS data in order to establish hardware-free traffic situation awareness and understanding for the purposes including, without limitation, traffic control, transportation planning, speed enforcement, first response tasks, business location analysis and more.

Currently, traffic maps make available the average speed on ‘fast-slow’ (Google traffic) or on quantitative, mph basis (Yandex traffic), as well as registered events, like incidents or repairs, and other information, like signs, traffic detectors, and other physical objects with, sometimes, the information they deliver. Usually, the speed of traffic at a road segment is indicated by color, and all other parameters— by graphical attributes [1, 2, and 3].

At certain periods of time, especially in congested traffic conditions which are the most challenging for the traffic control and emergency response activities, the majority of the roads look very similar, and sometimes equally “red”. Moreover, no difference can be noted between the road where speed is low due to the low road class, and the road where the speed is low due to huge traffic volume. That makes traffic situation awareness and situation understanding extremely difficult and consequently impedes the timely and effective decision making.

The goal of this invention is to develop an integrated system and method for visualization of traffic patterns based on combined utilization of all available knowledge, including GPS travel time and probe, as well as estimated or measured traffic flow volume data.

### BRIEF SUMMARY OF THE INVENTION

The present invention provides an integrated system and method for visualization of traffic patterns. It may apply to one or more road or road network.

The innovative automated system includes the components for collection of road data and detector information, GPS data gathering, traffic flow volume data estimation, and a map processor.

The system obtains information on each segment of road network, organizes segments into road sections and calculates speed and flow volume related parameters for each section, for each period of time. Further, the system defines maximal capacity for each section of the road. Based on the accumulated values, the system builds the map road network, assigning to each of the sections a specific color in accordance with the speed-related parameter, and assigning its width in accordance with the flow volume related parameter. Additional characteristics of the traffic patterns may be called by a click on a section.

### BRIEF DESCRIPTION OF DRAWINGS

FIG. 1. Operating scheme for the invention.

This figure is a block diagram showing functional components of the invention.

FIG. 2. Traffic map for the center of Boston, Mass., USA.

This figure allows a comparison of the performance of currently available traffic network maps (above, copied from Google), where all roads look very similar, and a map produced by present invention (below), which enables SASU at a glance by depicting both traffic speed and traffic volume for every part of the road network.

FIG. 3. Traffic patterns visualization map for a part of road network in Fremont, Calif.

This figure illustrates the example of use of the present invention for traffic planning purposes.

FIG. 4. Traffic patterns visualization map for a part of road network in Boston, Mass.

This figure illustrates the example of use of the present invention for the purpose of emergency response.

FIG. 5. Traffic patterns visualization map for a part of road network in Houston, Tex.

This figure illustrates the example of use of the present invention for the purpose of speed enforcement

### DETAILED DESCRIPTION OF THE INVENTION

The present invention provides an integrated system and method for visualization of traffic patterns. It may apply to one segment, several independent segments, a road or a road network. The visualization may apply to one or more segments, one or more roads, and road network(s).

The system obtains information on each segment of road network and describes the network as a number of connected sections. Each section may consist of one or several segments. Last segment of each section may have a substantial change in driving conditions on its end, e.g. traffic light, crossing, public transport stop, etc. The system uses the obtained information to calculate the road capacities for all sections based on the fundamental diagram with the use of speed limit parameter. Further, the system collects GPS-based information of traffic speed, probes and traffic events, along with traffic detection and traffic cameras data, where available. Based on current information on changes in traffic situation, like temporary obstacle or event registered by GPS, the system may reconsider section assignments as needed. Using the obtained, calculated and accumulated values, the system builds the road network map, assigning to each section its color in accordance with the speed-related parameter and its width in accordance with the flow volume related parameter. Additional characteristics of traffic patterns may be called by a click on a section.

Presently invented automated system consists of four components:

1. Road data collector (RDC);

2. Traffic detectors data collector (TDC)

3. GPS data collector (GDC);

4. Traffic volume estimator (TVE);

5. Data analyzer and map processor (DAMP).

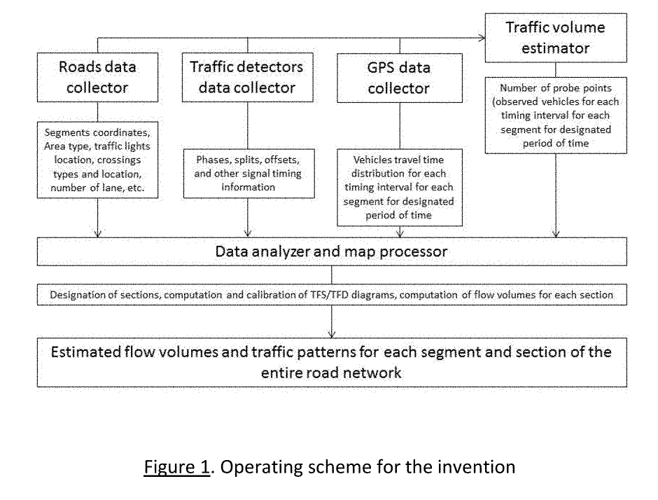

Operating scheme for the invention presented on FIG. 1.

RDC performs the following sequence of operation for road information collection and description:
Description of entire road network as a group of connected sections. Each section may consist of one or several segments. The last segment of each section may have a substantial change in driving conditions on its end, e.g. traffic light, crossing, public transport stop, etc., including temporary obstacle or event registered by GPS;
Collecting information on segments coordinates for each section. Note: segments are assigned by GPS provider which may be an in-house one or a third party;
Obtaining road pattern information for each segment, which may include a number of parameters sufficient for road capacity estimation in accordance with fundamental traffic flow theory [4];
Obtaining in the same way the road pattern information for each route that has a crossing with the controlled route. Forks or other kinds of junctions are also counted as crossings;
Collecting coordinates for traffic light positions, assigning them to the intersections and obtaining the signal timing data where available. This data may include any and all information used for effective green time calculation;
Submitting the information to TVE and DAMP.

TDC performs the following sequence of operations for traffic detector data collection and description:
Collecting coordinates for available positions of traffic detectors and traffic video cameras, and assigning them to the segments;
Arranging a database of time-related traffic detector data, as well as links for video cameras, both in relationship with the segments;
Submitting the information to TVE and DAMP.

GDC performs the following sequence of operations for travel time, probes and events data collection and description:
Continuously obtaining individual or aggregated travel time data for each segment for each available timing interval (usually scaled between 1 min and 1 h) from GPS provider;
Continuously obtaining individual or aggregated GPS probe data for each segment by recording each probe point, or obtaining number of probes and/or probe-related parameters, like confidence factor, for each available timing interval from GPS provider(s);
Continuously obtaining information about changes in traffic situation registered by GPS provider(s), such as incidents, road repairs or other events which may have influence on road capacity;
Performing preliminary processing of obtained data, excluding abnormal values and filtering outlier values using the ‘three sigma’ rule or any other suitable statistical method;
Generating, for each segment, the information on mean speed and speed distribution for each timing interval of each day of the week;
Storing and accumulating the produced information in a database which may be arranged on ‘day-of-week’ basis;
Submitting the information to TVE and DAMP.

TVE estimates traffic flow volume for each segment and section of road network based on GPS data and/or traffic detectors data, accumulating the produced information in a database which may be arranged on ‘day-of-week’ basis, and submits it to DAMP.

DAMP performs the following sequence of operation:
Obtaining informational request from the user. The request shall include traffic pattern characteristics desirable for the user. Such patterns characteristics may include, without limitation, one traffic flow volume related parameter, such as volume, volume/road capacity relationship, etc., and one speed-related parameter, such as speed, or speed/speed limit relationship, or speed/maximal observed speed relationship, or speed for a certain percentage of observed vehicles in relationship with speed limit, which will be reflected on the map. Additionally, the request may include a number of other traffic related parameters, suitable for situation awareness/situation understanding (SA/SU), which shall be available by a click on a segment;
Calculating desired parameters for all segments and sections of road network;
Producing the map, wherein a speed related parameter is reflected by color for each segment, and a flow volume related parameter is reflected by line width for each or segment or section of the road network, and all other traffic related parameters are available by a click on a segment.

Against the expectations based on established consensus, the authors found that presentation of road network as a number of connected sections, represented by different colors and widths in accordance with assigned speed-related and traffic-related parameters, culminates in unexpected opportunity of visual situation awareness/situation understanding at a glance, which is extremely important for a number of practical tasks in variety of industries. Availability to call up additional information by a click on a particular segment, selected on the basis of SA/SU for the area, greatly enhances the useful applicability of this invention. Additionally, such a presentation of a road network enabling innovative opportunity to explore actual performance of the roads and parts of road network.

### Example

The example below illustrates the use of the invention for traffic pattern visualization for Fremont, Calif., for Boston, Mass. and for Houston, Tex.

The description of road network was done using open source GIS system. Signal timing information had been obtained from local authorities, where available. GPS data was obtained from a major navigation provider which has global market presence. Traffic detector data, where available, had been obtained from public and private sources.

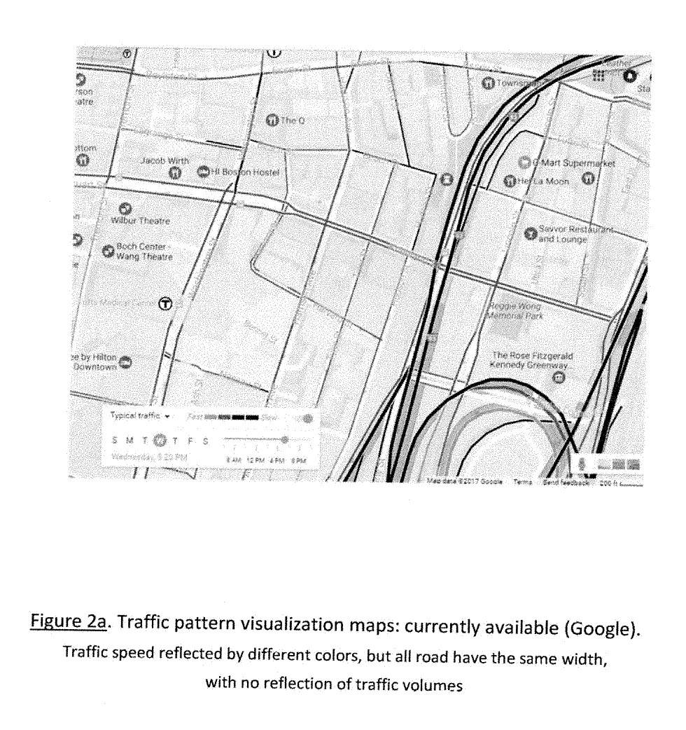

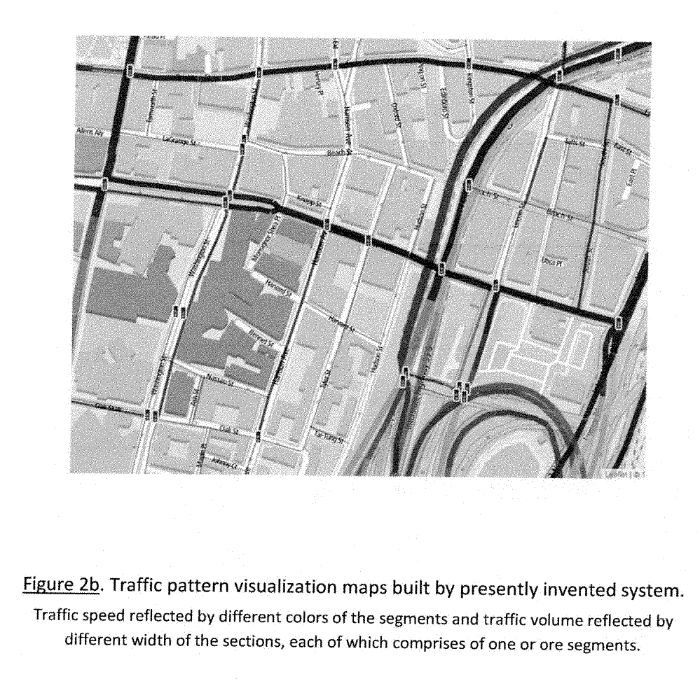

FIG. 2 allows comparing of currently available tools for visualization of traffic patterns (Google map) and the map built by presently invented system on the example of the City of Boston, Mass. Both maps reflect the same time and place. From the map built by presently invented system one can identify the difference between roads classes and a degree of roads use at a glance.

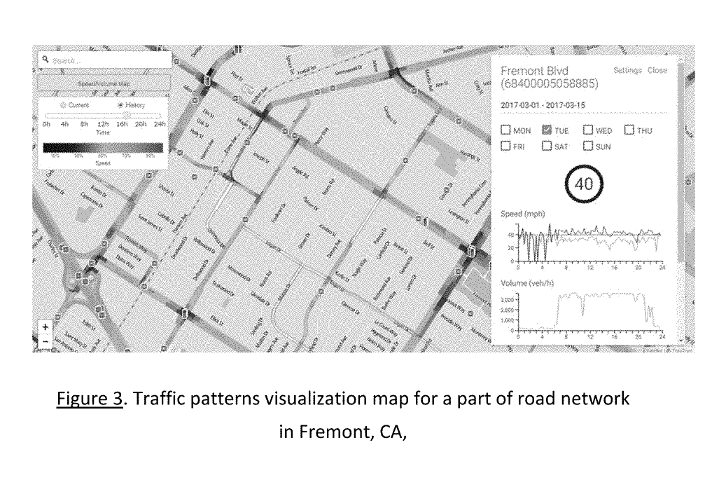

FIG. 3 illustrates the use of present invention for the purpose of traffic planning on the example of Fremont, Calif. road network. Observed traffic pattern here are:
median speed, as a percentage from assigned speed limit (shown by section color);
traffic flow volume, veh/h (shown by section width).

Traffic detectors are shown on the map with clickable graphical attributes. On a side panel, additional information is displayed (speed-time and volume-time graphs in relationship with days of week).

Looking at the map, a traffic engineer can instantly visualize the problematic segments/sections/roads, where real traffic speed is substantially below the desired level, assigned as a speed limit. Further exploration of problematic areas may be easily done with the help of additional information, displayed on the side panel for a desired segment and from detector information, displayed via a click on corresponding graphical attribute.

For the purpose of traffic planning, both historic traffic patterns and current traffic patterns may be used.

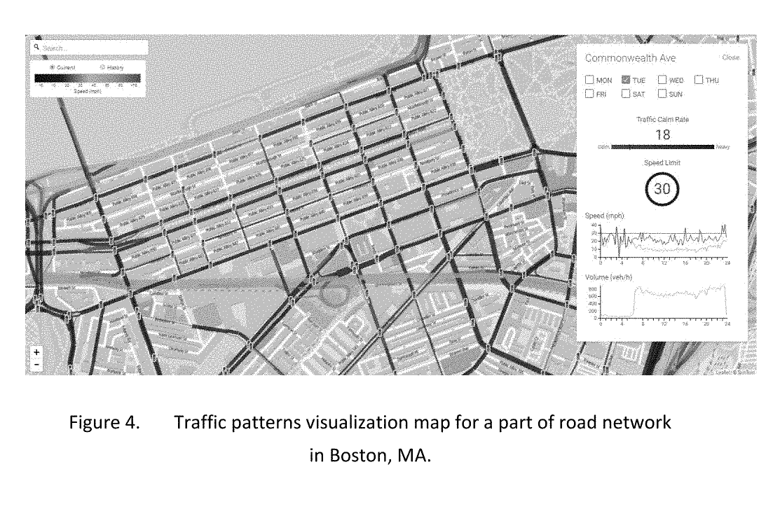

FIG. 4 (Boston, Mass.) illustrates the use of present invention for the purpose of emergency response. Observed traffic pattern here are:
median speed, mph (shown by section color);
traffic flow volume, veh/h (shown by section width).

Looking at the map, an emergency responder or situational manager can instantly visualize both traffic speed and volume distribution in the area of responsibility. This expedites the selection of the best deployment route for the task force, as well quick identification of the crowded or blocked routes.

For the purpose of emergency response, the use of current traffic patterns may be prevalent over the use of historical traffic pattern data.

More information about all segments is still available on the side panel.

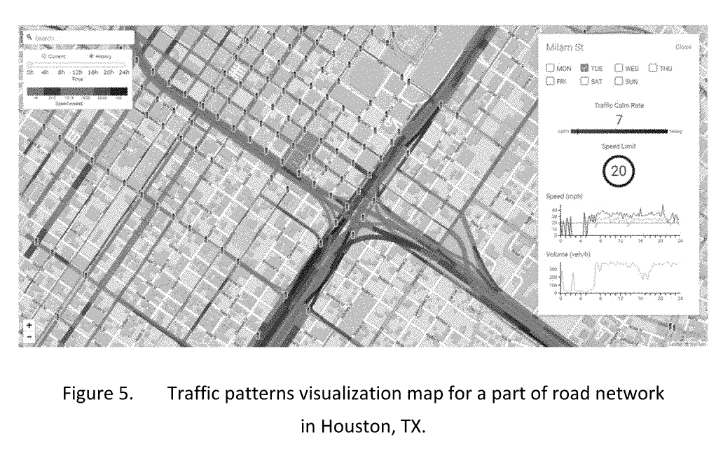

FIG. 5 (Houston, Tex.) illustrates the use of present invention for the purpose of speed limit enforcement. Observed traffic patterns here are:
5 or more percent exceeding the speed limit by estimated number of vehicles (shown by section color);
estimated number of vehicles per hour (traffic flow volume, veh/h), shown by section width.

Looking at the map, the patrol officer can pick up the problematic areas where speed violations are occurring more frequently, and where a number of violators is expected to be greater. On the side panel (see speed-time graph) it is possible to note the difference between median traffic flow speed (represented by lower curve) and violators' speed (represented by higher curve) in relationship with the speed limit (represented by horizontal line).

Accordingly to violations frequency and importance, optimal and most efficient patrol routes can be assigned.

### REFERENCES

1. U.S. Pat. No. 8,694,241 B1 from Apr. 8, 2014. Visualization of traffic patterns using GPS data.
2. Patent US 2013/0332056 A1 from Dec. 12, 2013. Harvesting traffic information from mobile devices.
3. Patent US 20090082950 A1 from Oct. 6, 2008. System for transmitting, processing, receiving, and displaying traffic information.
4. N. J. Garber, L. A. Noel. Traffic and Highway Engineering. Second edition, PWS Publishing Co, NY, 1110 p, 2012.

1. A computer system comprising road data collector, traffic detector data collector, GPS data collector, traffic volume estimator, and analyzer and map processor for visualization of traffic patterns, wherein all constituents are employed for combined operation.

2. A method for visualization of traffic patterns, wherein traffic patterns are visualized by presenting a road as a group of connected sections, each of which consists of one or more segments, with the assignment to each segment a specific color in accordance with registered traffic speed, and the assignment for each section a specific width in accordance with registered or estimated traffic flow volume.

3. A method of claim 2, wherein a specific color may be assigned to a segment of the road in accordance with complex traffic speed related parameter, which may represent a relationship between speed of traffic flow or its part, as well as traffic speed distributions characteristic and traffic volume, percentage of traffic volume, road traffic capacity, assigned speed limit, or any combination of said parameters.

4. A method of claim 2, wherein a specific width may be assigned to a section of the road segment in accordance with complex traffic volume related parameter, which may represent a relationship between traffic volume and traffic speed, road traffic capacity, GPS probe-related parameter, or combination of said parameters.
